(19) United States
(12) Patent Application Publication
(10) Pub. No.: US 2025/0096360 A1
(43) Pub. Date: Mar. 20, 2025

(54) DIRECTED COOLING THERMAL MANAGEMENT SYSTEM AND METHOD OF OPERATION

(71) Applicant: SPEED CHARGE, LLC, Carter Lake, IA (US)

(72) Inventors: Arvinth Rathinam, Sunnyvale, CA (US); Richard Steele, Pflugerville, TX (US); Nicholas Seroff, San Jose, CA (US)

(21) Appl. No.: 18/891,903

(22) Filed: Sep. 20, 2024

Related U.S. Application Data
(60) Provisional application No. 63/539,511, filed on Sep. 20, 2023.

(51) Int. Cl. H01M 10/6565; H01M 10/48; H01M 10/613; H01M 10/63

(52) U.S. Cl. CPC H01M 10/6565; H01M 10/486; H01M 10/613; H01M 10/63

(57) ABSTRACT

A directed cooling system including a pack housing defining an enclosed volume. Additionally, the directed cooling system includes a first battery module disposed within the enclosed volume and a second battery module disposed within the enclosed volume adjacent the first battery module. The directed cooling system further includes an air cycle system operating in a first mode and a second mode. In the first mode, the air cycle system passes an airflow into the enclosed volume, over the first battery module in a first direction, over the second battery module in the first direction, and out of the enclosed volume. In the second mode, the air cycle system passes the airflow into the enclosed volume, over the second battery module in a second direction, opposite the first direction, over the first battery module in the second direction, and out of the enclosed volume.

### CROSS-REFERENCE TO RELATED APPLICATIONS

This application claims priority to and the benefit of the filing date of U.S. Provisional Application No. 63/539,511, filed Sep. 20, 2023. The entire contents of which is incorporated herein by reference.

### FIELD

The present disclosure relates to directed cooling system and method of operation.

### BACKGROUND

Electrical energy can be stored in batteries and conveyed via electrically conductive materials. In such examples, the batteries and conductive materials will heat up when electrical energy is conveyed. The amount of heat generated is typically proportional to the amount of electrical energy being conveyed

In some examples, the electrical components convey energy and the heat generated in passing electrical energy dissipates via natural convection. In other examples, the heat generated by electrical components is sufficiently great that the electrical components require a cooling structure.

### SUMMARY

Disclosed herein is a directed cooling system including a pack housing defining an enclosed volume. The directed cooling system also including a first battery module disposed within the enclosed volume and a second battery module disposed within the enclosed volume adjacent the first battery module. The directed cooling system further includes an air cycle system operating in a first mode and a second mode. In the first mode the air cycle system passes an airflow into the enclosed volume, over the first battery module in a first direction, over the second battery module in the first direction, and out of the enclosed volume. And, in the second mode, the air cycle system passes the airflow into the enclosed volume, over the second battery module in a second direction, opposite the first direction, over the first battery module in the second direction, and out of the enclosed volume.

In some variations, the second battery module is disposed adjacent to the first battery module in the first direction. Additionally, the directed cooling system may further include a third battery module disposed adjacent to the first battery module in a third direction and a fourth battery module disposed adjacent to the third battery module in the first direction and adjacent to the second battery module in the third direction.

In other variations, the air cycle system further comprises a first header and a second header. In the first mode, the air cycle system passes the airflow in a third direction through the first header, over the first battery module and the third battery module in the first direction, over the second battery module and the fourth battery module in the first direction, and in a fourth direction, opposite the third direction, through the second header. Additionally, in the second mode, the air cycle system passes the airflow in a third direction through the second header, over the second battery module and the fourth battery module in the second direction, over the first battery module and the third battery module in the second direction, and in a fourth direction, through the first header. In some such examples, the directed cooling system further comprising at least one first aerodynamic structure in the first header and at least one second aerodynamic structure in the second header configured to uniformly distribute the airflow in the first header and the second header, respectively.

In further variations, the directed cooling includes a heat pump disposed outside the pack housing and configured to absorb heat from the airflow before passing the airflow into the pack housing.

In yet other variations, the directed cooling system includes a switch having a first state and a second state and the air cycle system operates in the first mode when the switch is in the first state and the air cycle system operates in the second mode when the switch is in the second state. In some such examples, the switch comprises at least one temperature sensor actuatable between the first state and the second state when a temperature satisfies a threshold. The temperature sensor may disposed on or in one of the first battery module and the second battery module. In some such examples, the air cycle system further comprises a heat pump.

Also disclosed herein is a directed cooling system including a pack housing defining an enclosed volume having a first side and a second side disposed opposite the first side. The pack housing includes a proximal battery module disposed within the enclosed volume adjacent the first side and a distal battery module disposed within the enclosed volume adjacent the proximal battery module. The directed cooling system also includes a first header disposed on the first side of the enclosed volume and including a first aerodynamic structure and a second header disposed on the second side of the enclosed volume and including a second aerodynamic structure. Additionally, a plurality of channels are disposed between the first side and the second side, a first channel disposed adjacent the proximal battery module, a second channel disposed between the proximal and distal battery modules, and a third channel disposed adjacent the distal battery module, the directed cooling system further includes an air cycle system passing an airflow into the enclosed volume through the first header, through the first, second, and third channels and over the proximal and distal battery modules, and out of the enclosed volume through the second header.

In some variations, the air cycle system further includes a first mode and a second mode. In the first mode the air cycle system passes an airflow into the enclosed volume through the first header in a third direction, through the first, second, and third channels and over the first and second battery modules in a first direction; and out of the enclosed volume through the second header. In the second mode the air cycle system passes the airflow into the enclosed volume through the second header in a third direction, through the first, second, and third channels and over the first and second battery modules in a second direction; and out of the enclosed volume through the second header.

In other variations, the directed cooling system includes a switch having a first state and a second state. In such examples, the air cycle system operates in the first mode when the switch is in the first state and the air cycle system operates in the second mode when the switch is in the second state. Additionally, the switch includes at least one temperature sensor actuatable between the first state and the second state when the temperature satisfies a threshold. Further, the temperature sensor is disposed on or in at least one of the first battery module and the second battery module.

In further variations, the directed cooling system includes a first temperature sensor disposed on the first battery module and a second temperature sensor disposed on the second battery module. In such examples, the aerodynamic structure is actuatable between a first state when the first temperature sensor satisfies a first threshold, a second state when the second temperature sensor satisfies a second threshold, and a third state when the first and second temperatures either do not satisfy the first and second thresholds, respectively, or satisfy the first and second thresholds, respectively. In the first state, the aerodynamic structure passes more airflow over the first battery module and less airflow over the second battery module; in the second state, the aerodynamic structure passes more airflow over the second battery module and less airflow over the first battery module; and, in the third state, the aerodynamic structure passes airflow uniformly over the first battery module and the second battery module. In some such examples, the aerodynamic structure is configured to distribute the airflow between the plurality of channels.

In yet other variations, the air cycle system further comprises a heat pump.

Also disclosed herein is a method of operating a cooling system comprising at least two battery modules disposed adjacent one another in a first direction within a pack housing via an air cycle system. The method includes providing a processor in communication with the air cycle system and at least one temperature sensor disposed on or in each of the at least two battery modules. The method also includes operating the air cycle system, via the processor, in a first mode including passing an airflow over a first battery module in the first direction and over a second battery module in the first direction. Additionally, the method includes receiving, at the processor, a signal from the at least one temperature sensor disposed on or in the second battery module, wherein the signal is in response to the at least one temperature sensor satisfying a temperature threshold. Also, the method includes operating the air cycle system, via the processor and in response to the signal from the at least one temperature sensor, in a second mode including passing the airflow over the second battery module in a second direction, opposite the first direction and over a first battery module in the second direction.

In some examples, the second battery module is disposed adjacent to the first battery module in the first direction, and further comprising a third battery module disposed adjacent to the first battery module in a third direction a fourth battery module disposed adjacent to the third battery module in the first direction and adjacent to the second battery module in the third direction. The cooling system may further include a first air header including a first actuatable aerodynamic surface disposed adjacent the first and third battery modules and a second air headers including a second actuatable aerodynamic structure disposed adjacent the second and fourth battery modules, the method further comprising. In such examples, the method may include controlling, via the processor, the first actuatable aerodynamic surface to distribute the airflow over the first and third battery modules in the first mode. Additionally, the method may include controlling, via the processor, the second actuatable aerodynamic surface to distribute the airflow over the second and fourth battery modules in the second mode.

The directed cooling system may include at least one second temperature sensor disposed on or in the third battery module or the fourth battery module. In some examples, the first and second actuatable aerodynamic surfaces are actuatable between a first state when the at least one first temperature sensor satisfies a first threshold and a second state when the at least one second temperature sensors satisfies a second threshold. In the first state, the first actuatable aerodynamic surface passes more airflow over the first battery module and less airflow over the third battery module and in the second state, the first actuatable aerodynamic surface passes more airflow over the second battery module and less airflow over the first battery module.

### BRIEF DESCRIPTION OF THE DRAWINGS

The present disclosure is described in the following detailed description in conjunction with the drawings, wherein:

FIG. 1 is a perspective view of an array of battery pack modules used in accordance with the presently disclosed directed cooling system.

FIG. 2 is a front view of an example directed cooling system operating in a first mode

FIG. 3 is a front view of the example directed cooling system of FIG. 1 operating in a second mode.

FIG. 4 is a front view of another example directed cooling system operating in a first mode with aerodynamic surfaces disposed in a first state.

FIG. 5 is a front view of the example directed cooling system of FIG. 4 operating in a first mode with aerodynamic surfaces disposed in a second state.

FIG. 6 is a front view of the example directed cooling system of FIG. 4 operating in a first mode with aerodynamic surfaces disposed in a third state.

FIG. 7 is a front view of another example directed cooling system operating in a first mode with aerodynamic surfaces disposed in a first state.

FIG. 8 is a front view of the example directed cooling system of FIG. 4 operating in a first mode with aerodynamic surfaces disposed in a second state.

FIG. 9 is a front view of the example directed cooling system of FIG. 4 operating in a first mode with aerodynamic surfaces disposed in a third state.

FIG. 10 is a system diagram of a directed cooling system in accordance with the present disclosure.

FIG. 11 is a flow chart depicting a method of using a directed cooling system.

FIG. 12 is a flow chart depicting another method of using a directed cooling system.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

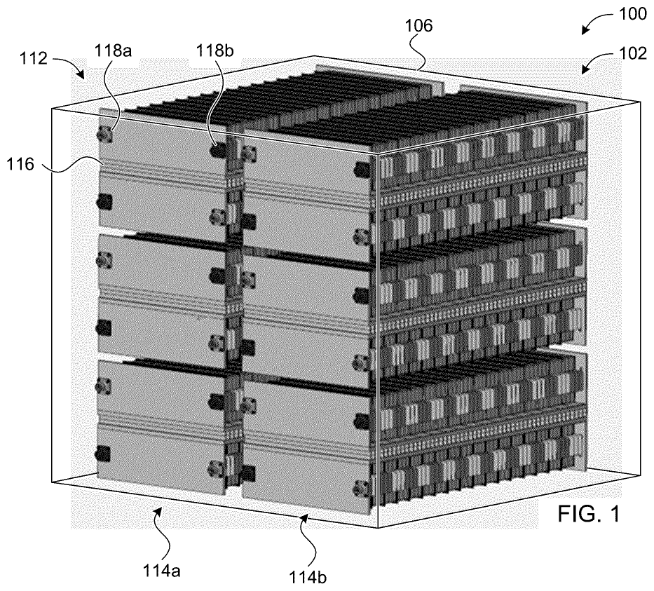

FIG. 1 illustrates an array 100 of battery pack modules 102 used in accordance with the presently disclosed directed cooling system 200. The array 100 of battery pack modules 102 are disposed within an enclosed pack housing 106. In the illustrated example, the array 100 includes twelve battery pack modules 112 evenly distributed amongst a first column 114a and a second column 114b. In various examples, some of the battery pack modules 102 may include heat sinks 116. As shown in FIG. 1, the heat sinks 116 are disposed between adjacent battery pack modules 102 in the same column 114a, 114b. The heat sinks 116 are configured to assist in convective heat transfer to cool the battery pack modules 102.

Each battery module 102 includes a first terminal 118a and a second terminal 118b to charge and discharge each battery module 102. In various examples, the battery modules 102 can be connected in series, in parallel, or in a combination of in series and in parallel. When charging and discharging electrical energy, the battery pack modules warm up. In some examples, the rapid or extended heating of the battery pack modules 102 can result in decreased battery life, damage, and/or fire. To improve the life and safety of the array 100 of battery pack modules 102, the array 100 may be actively cooled with chilled air or liquid.

Cooled air can be passed over the battery pack modules 102, and, in some examples, through the heat sinks 116. In some such examples, the heat sinks 116 may include channels through which an airflow can flow. In such examples, the cooled air absorbs heat in the battery modules 102 and the heat sinks 116, cooling down the battery modules but warming up the cooled air proportionally. As the cooled air warms up, it becomes less effective at absorbing additional heat from the battery pack modules 102 and the heat sinks 116. As a result, cooled air passing over a first battery pack module 118a and subsequently over a second battery pack module 118b will cool the first battery pack module 118a more than the second battery pack module 118b. In such examples, the second battery pack module 118b may be slightly or significantly warmer than the first battery pack module 118a.

In accordance with the present disclosure, the directed cooling system 200 controls an airflow passing over and around the array 100 of battery pack modules 102. In the present example, the directed cooling system 200 adjusts an airflow flowpath to first pass over a hotter battery pack module 102. For example, the directed cooling system 200 can pass a cooling airflow in a first direction in a first mode and a second direction in a second mode.

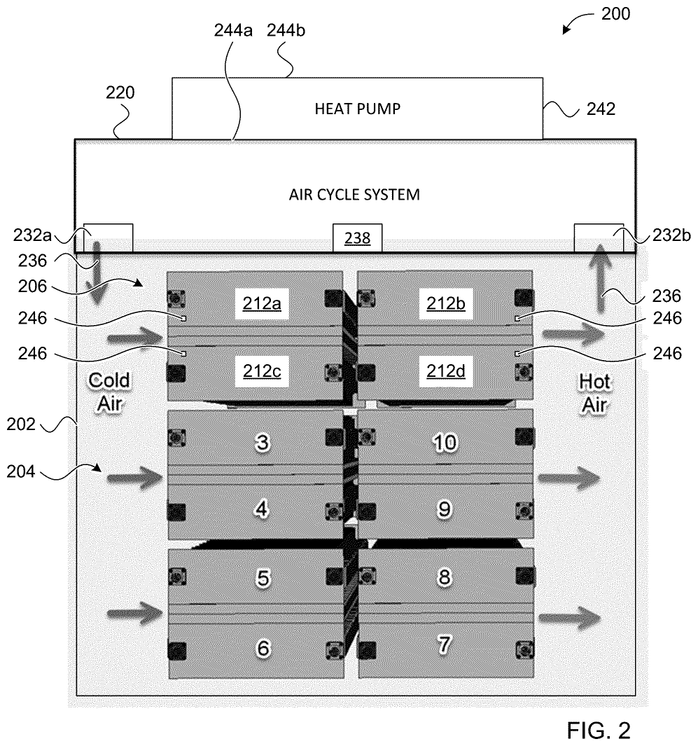

FIG. 2 illustrates the directed cooling system 200 operating in a first mode. The directed cooling system 200 includes a pack housing 202 defining an enclosed volume 204 having a plurality of battery modules 206. Additionally, the directed cooling system 200 includes at least a first battery module 212a, a second battery module 212b, a third battery module 212c, and a fourth battery module 212d. The first, second, third, and fourth battery modules 212a, 212b, 212c, 212d are disposed within the enclosed volume 204. The directed cooling system 200 further includes an air cycle system 220 including a heat pump 222. In various examples, the directed cooling system could include more or fewer components, such as more or fewer battery modules 206.

As illustrated in FIG. 2, the air cycle system 220 includes a first vent 232 and a second vent 234 through which an airflow 236 can be passed into and out of the enclosed volume 204 of the pack housing 202. In various examples, the air cycle system 220 includes components to generate the airflow 236 within the pack housing 202. For example, the air cycle system 220 could include a fan, a compressor, a vacuum, a similar mechanism, and/or combination of the foregoing to generate the airflow 236. Additionally, in preferred examples, the first vent 232 and the second vent 234 are disposed on opposite sides of the pack housing 202 to cause the airflow 236 to pass through the enclosed volume 204. In some examples, the first vent 232 and the second vent 234 each include a vertical fan operable in a first direction and a second direction, opposite the first direction. In some examples, the first and second vents 232, 234 each include multiple fans operable in both the first and second directions.

In various examples, the heat pump 242 could comprise any structure or apparatus for cooling the airflow 236. In some examples, the heat pump 242 could use the refrigeration cycle to remove heat from a low temperature area and transfer the heat to a high temperature area. In such examples, the heat pump 242 has a cold side 244a and a hot side 244b. The air cycle system 220 passes the airflow 236 over the cold side 244a of the heat pump before the airflow 236 is passed into the pack housing 202. Passing the airflow 236 over the cold side 244a of the heat pump 238 cools the airflow.

In some examples, the airflow 236 recirculates through the enclosed volume 204 of the pack housing 202 and the air cycle system 220 creates a closed loop. In other examples, the airflow 236 passes from outside the pack housing 202. In either example, the airflow 236 is cooled below the operating temperature of the battery modules 206 disposed within the pack housing 202. The cold airflow 236 absorbs heat via forced convective heat transfer when the airflow 236 passes over the battery modules 206.

As illustrated in FIG. 2, the cooled airflow 236 first passes through the vent 232, over the first battery module 212a, then passes over the second battery module 212b and through the vent 234. As shown in FIG. 2, the airflow 236 is generally circulating counterclockwise. The cooled airflow 236 warms as it passes over the first battery module 212a and less efficiently cools the second battery module 212b. As a result, during extended use and operation, the second battery module 212b may get warmer than the first battery module 212a. In various examples, each battery module may include a temperature sensor 242 disposed on, in, or adjacent to each of the battery modules 206. In other examples, only some of the battery modules 206 include a temperature sensor 242. The temperature sensors 242 are in electrical communication with a processor 244 capable of controlling operation of the air cycle system 220.

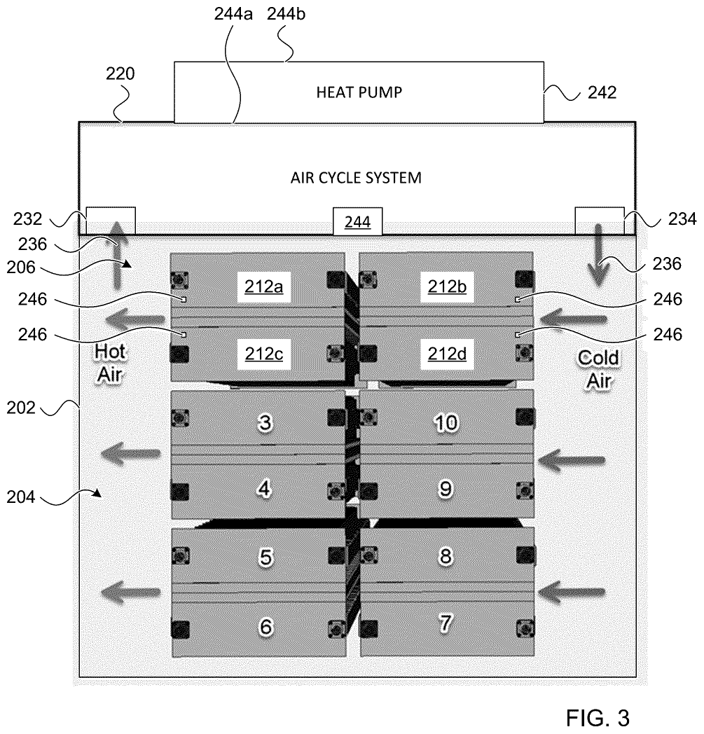

FIG. 3 illustrates the directed cooling system 200 of FIG. 1 operating in a second mode. In the second mode, the direction of the airflow 236 is reversed and generally flows, as shown in FIG. 3, clockwise. As a result, the airflow 236 first passes through the vent 234, over the second battery module 212b, then passes over the first battery module 212a and through the vent 232. Because the cooled airflow first passes over the second battery module 212b and subsequently passes over the first battery module 212a, the second battery module 212b may cool more than the first battery module 212a.

In the present example, the temperature sensor 242 disposed on the second battery module 212b satisfied a temperature threshold. For instance, the temperature threshold may be satisfied when the temperature sensor 242 detects that the second battery module 212b is warmer than 150 degrees Fahrenheit (° F., approximately 65.5 degrees Celsius (C)). In such an example, the threshold is set prior to the second battery module 212b is damaged due to overheating. Alternatively, the temperature threshold could be satisfied at a lower temperature (e.g., 125° F. (approximately 52° C.), 115° F. (approximately 46° C.).

When the processor 244 receives a signal from one of the temperature sensors 242 that the temperature threshold is satisfied, the processor 244 will control the air cycle system to transition from a first mode to a second mode, or vice versa. For example, if the air cycle system 220 is operating in the first mode (shown in FIG. 2) and the temperature sensor 242 detects the second battery module 212b has satisfied the temperature threshold, the processor 244 will cause the air cycle system to operate in the second mode (shown in FIG. 3) thereby passing colder air over the second battery module 212b. Alternatively, if the air cycle system 220 is operating in the second mode (shown in FIG. 3) and the temperature sensor 242 detects the first battery module 212a has satisfied the temperature threshold, the processor 244 will cause the air cycle system to operate in the first mode (shown in FIG. 2) thereby passing colder air over the first battery module 212a. As a result, by switching operating modes, the air cycle system 220 can maintain all batteries within the pack housing 202 at acceptable temperatures. In other examples, the processor 244 could switch between the first mode and the second mode based on a timer.

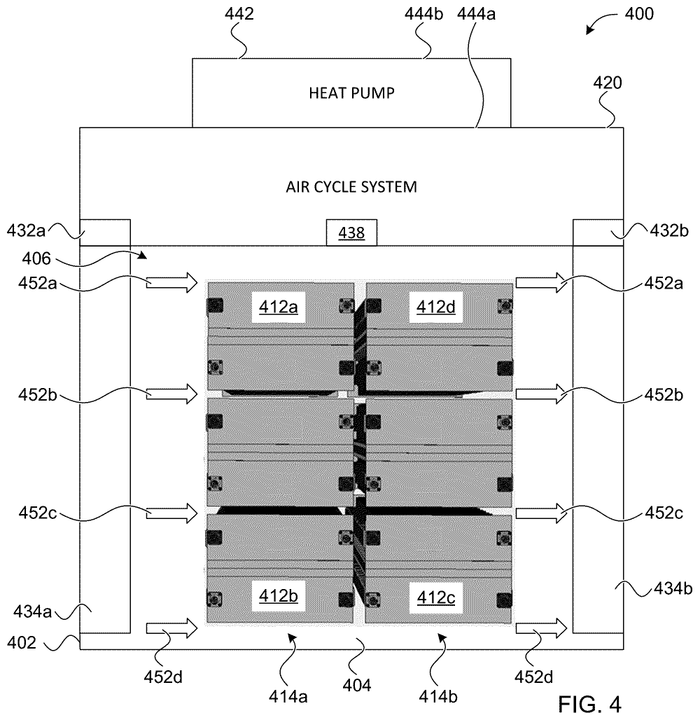

FIG. 4 illustrates another directed cooling system 400 operating in a first mode with aerodynamic surfaces disposed in a first state. The directed cooling system 400 includes a pack housing 402 defining an enclosed volume 404 having a plurality of battery modules 406. Additionally, the directed cooling system 400 includes at least a first battery module 412a, a second battery module 412b, a third battery module 412c, and a fourth battery module 412d. The first, second, third, and fourth battery modules 412a, 412b, 412c, 412d are disposed within the enclosed volume 404. The directed cooling system 400 further includes an air cycle system 420 including a heat pump 422. In various examples, the directed cooling system 400 could include more or fewer components, such as more or fewer battery modules 406.

As illustrated in FIG. 4, the air cycle system 420 includes a first vent 432 and a second vent 434 through which an airflow 436 can be passed into and out of the enclosed volume 404 of the pack housing 402. In various examples, the air cycle system 420 includes components to generate the airflow 436 within the pack housing 402. For instance, the air cycle system 420 could include a fan, a compressor, a vacuum, a similar mechanism, and/or combination of the foregoing to generate the airflow 436. Additionally, in preferred examples, the first vent 432 and the second vent 434 are disposed on opposite sides of the pack housing 402 to cause the airflow 436 to pass through the enclosed volume 404.

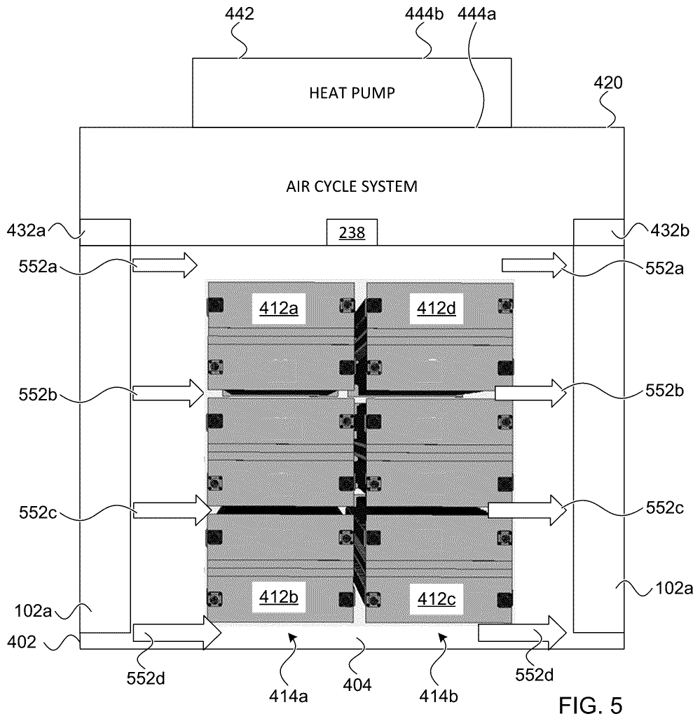

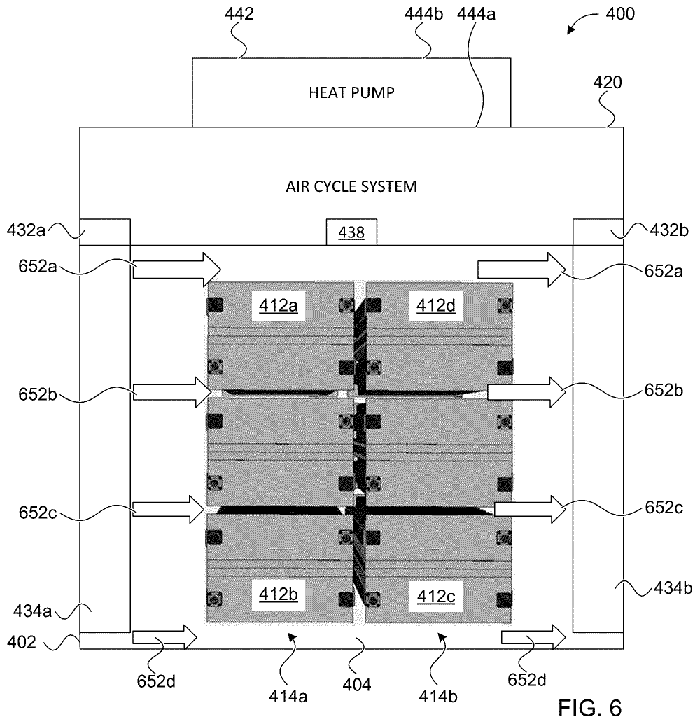

Additionally, the directed cooling system 400 includes a first header 434a in fluid communication with the first vent 432a and a second header 434b in fluid communication with the second vent 432b. The first header 434a and the second header 434b include aerodynamic structures and/or surfaces capable of distributing the airflow 436 along the first header 434a and the second header 434b, respectively. In some examples, the aerodynamic structures are actuatable between at least a first state, a second state, and a third state. For example, the first and second headers 434a, 434b can uniformly distribute the airflow 436, or increase the airflow within a region of the pack housing 402. The first state is shown in FIG. 4, the second state is shown in FIG. 5 and the third state is shown in FIG. 6.

In various examples, one or both of the first and second headers 434a, 434b include structures to distribute airflow 436. In one example, the aerodynamic structure could include a manifold with orifices of varying size to evenly distribute air from the top of the pack housing 402 to the bottom of the pack housing 402. In such an example, to evenly distribute the airflow vertically in the pack housing 402, the orifices are smaller at the top of the pack housing 402 and larger at the bottom of the pack housing 402. In other examples, the size of the orifices could be actuated to control the distribution of airflow in the pack housing 402.

The heat pump 442 could comprise any structure or apparatus for cooling the airflow 436. In some examples, the heat pump 442 could use the refrigeration cycle to remove heat from a low temperature area and transfer the heat to a high temperature area. In such examples, the heat pump 442 has a cold side 444a and a hot side 444b. The air cycle system 420 passes the airflow 436 over the cold side 444a of the heat pump before the airflow 436 is passed into the pack housing 402. Passing the airflow 436 over the cold side 444a of the heat pump 442 cools the airflow.

In some examples, the airflow 436 recirculates through the enclosed volume 404 of the pack housing 402 and the air cycle system 420 creates a closed loop. In other examples, the airflow 436 passes from outside the pack housing 402. In either example, the airflow 436 is cooled below the operating temperature of the battery modules 406 disposed within the pack housing 402. The cold airflow 436 absorbs heat via forced convective heat transfer when the airflow 436 passes over the battery modules 406.

As illustrated in FIG. 4, the cooled airflow 436 first passes through the vent 432a, through a first header 434a over a first column of the battery modules 406, then passes over the second column of battery modules 406, then through the second header 434b and through the vent 432b. As shown in FIG. 4, the airflow 436 is generally circulating counterclockwise. Because the first and second headers 434a, 434b are in the first state, the airflow 436 is uniformly distributed along the height of the first and second columns 414a, 414b. As described in connection with FIG. 2, the cooled airflow 236 warms as it passes over the first battery module 212a and less efficiently cools the second battery module 212b.

FIG. 5 illustrates the directed cooling system 400 of FIG. 4 operating in a first mode with aerodynamic surfaces disposed in a second state. In contrast to the directed cooling system 400 with the first and second headers 434a, 434b operating in the first state, the first and second headers 434a, 434b are not uniformly distributing the airflow 436. As shown in FIG. 5, with the first and second headers 434a, 434b operating in the second state, the airflow 436 is concentrated towards a third battery module 412c and a fourth battery module 412d disposed at a distal end of the first and second columns 414a, 414b relative to the vents 432a, 432b. Consequently, less airflow 436 passes over the first battery module 412a.

FIG. 6 illustrates the directed cooling system 400 of FIG. 4 operating in a first mode with the first and second headers 434a, 434b disposed in a third state. In contrast to the directed cooling system 400 with the first and second headers 434a, 434b operating the first state shown in FIG. 4 and the second state shown in FIG. 5, the first and second headers 434a, 434b are concentrating the airflow 436 towards the first battery module 412a and the second battery module 412b disposed at a proximal end of the first and second columns 414a, 414b, relative to the vents 432a, 432b. Consequently, less airflow 436 passes over the second battery module 412b.

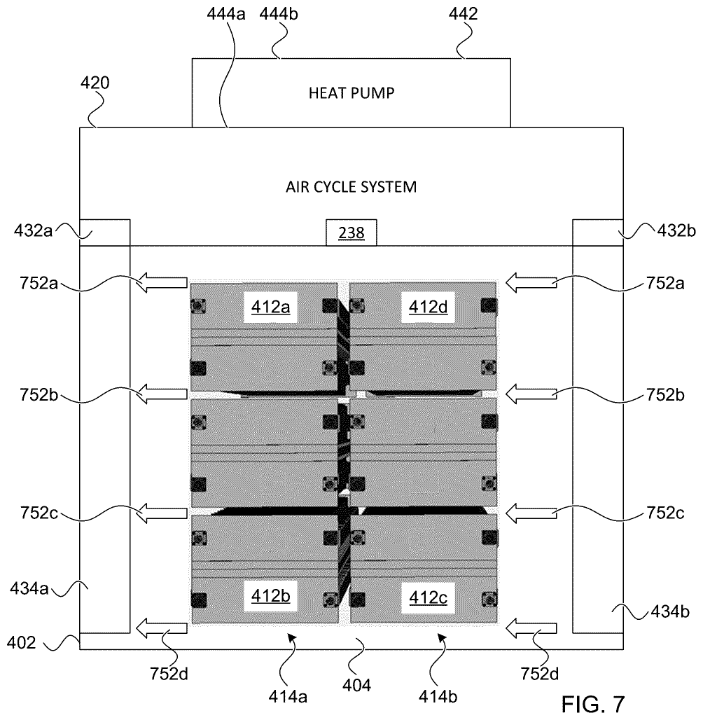

FIG. 7 illustrates the directed cooling system 400 operating in a second mode with aerodynamic surfaces disposed in a first state. As discussed in connection with FIG. 3, the processor 438 controls the operation of the air cycle system 420 and causes the air cycle system to switch operation from the first mode to the second mode. Similar to the directed cooling system 200, in the first mode the airflow 436 flows generally counterclockwise. As a result, in the first mode, the airflow 436 first passes over the first column 414a and in the second mode, the airflow 436 first passes over the second column 414b.

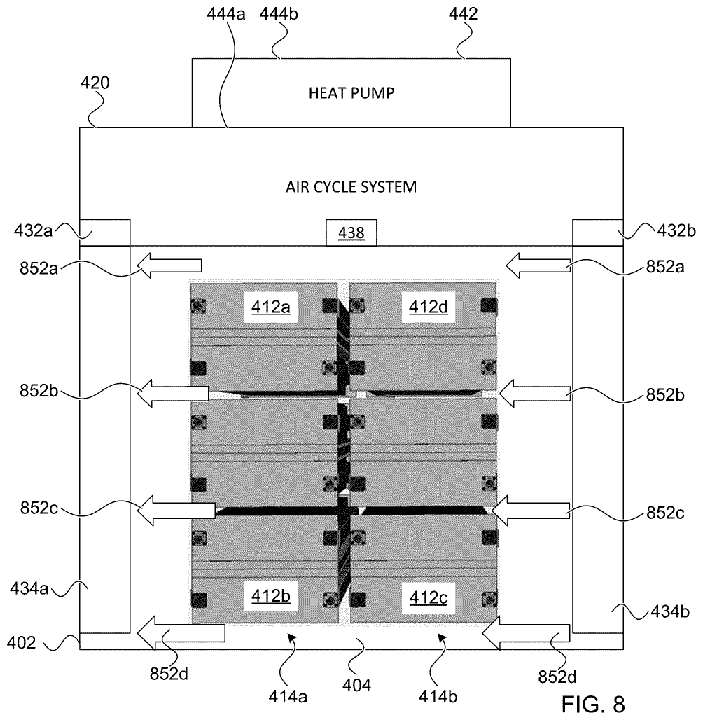

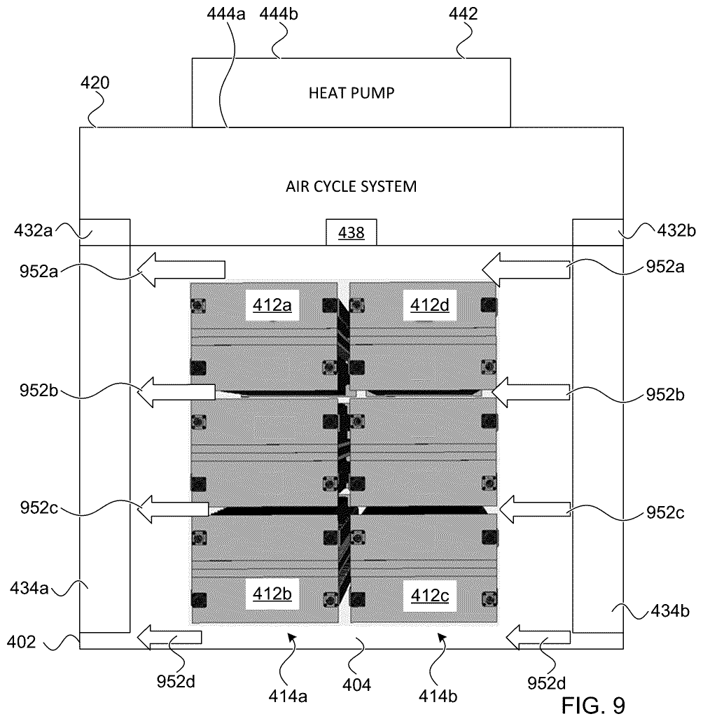

FIGS. 8 and 9 illustrate the directed cooling system of FIG. 4 operating in a second mode with aerodynamic surfaces disposed in the second state and third state, respectively. Similar to the second state discussed in connection with FIG. 6, the first and second headers 434a, 434b in the second state concentrate airflow at a distal end of the first and second columns 414a, 414b. Alternatively, similar to the third state discussed in connection with FIG. 7, the first and second headers 434a, 434b in the third state concentrate airflow at a proximal end of the first and second columns 414a, 414b.

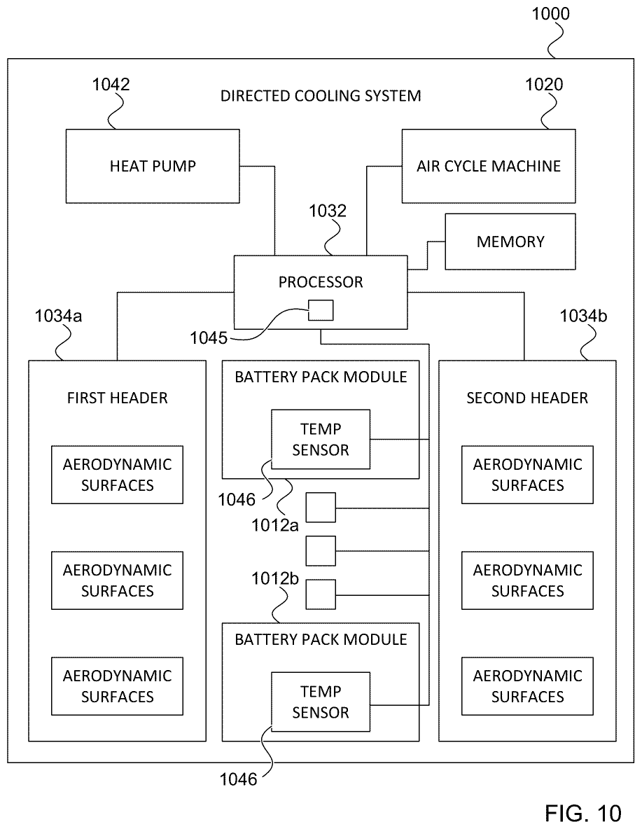

FIG. 10 illustrates a directed cooling system 1000 in accordance with the present disclosure. The directed cooling system 1000 could be the directed cooling system 200 of FIG. 2 or the directed cooling system 400 of FIG. 4. For example, the directed cooling system 1000 includes an air cycle machine 1020; a processor 1032; a heat pump 1042; battery modules 1012a, 1012b; and, in some examples, a first and second header 1034a, 1034b.

In the directed cooling system 1000, the processor 1032 is in electrical communication with one or more of the air cycle machine 1020, the heat pump 1042, the first and second headers 1034a, 1034b, and temperature sensors 1046 disposed on the battery modules 1012a, 1012b. For example, the processor 1032 receives temperature data generated at the temperature sensors 1046. The processor 1032 then compares the temperature data to temperature thresholds stored in a memory 1036. If the processor 1032 determines the temperature data satisfies a temperature threshold stored in the memory 1036, the processor 1032 sends control signals to at least one of the air cycle system 1020 and the first and second headers 1034a, 1034b.

In some examples, the processor 1032 includes a switch 1045 that has a first state and a second state. In various examples, the switch 1045 may be a mechanical switch or a programmed switch. As illustrated in FIG. 10, the switch is part of the processor 1032, but in other examples, the switch 1045 comprises the temperature sensors 1046. In some examples, when the switch 1045 is in the first state, the processor 1032 causes the air cycle system 1020 to operate in the first mode and when the switch 1045 is in the second state, the processor 1032 causes the air cycle system 1020 to operate in the second mode.

The processor 1032 sends a control signal to the air cycle system 1020 to cause the air cycle system to operate in a first mode (illustrated in FIGS. 2 and 4-6) or in a second mode (illustrated in FIGS. 3 and 7-9). Similarly, the processor 1032 sends a control signal to the first and second headers 1034a, 1034b to cause the first and second headers 1034a, 1034b to operate in a first state (illustrated in FIGS. 4 and 7), a second state (illustrated in FIGS. 5 and 8), and a third state (illustrated in FIGS. 6 and 9). In some examples, the air cycle system 1020 and the first and second headers 1034a, 1034b have their own processors that receive a control signal from the processor 1032 to control the functioning of the air cycle system 1020 and the first and second headers 1034a, 1034b, respectively.

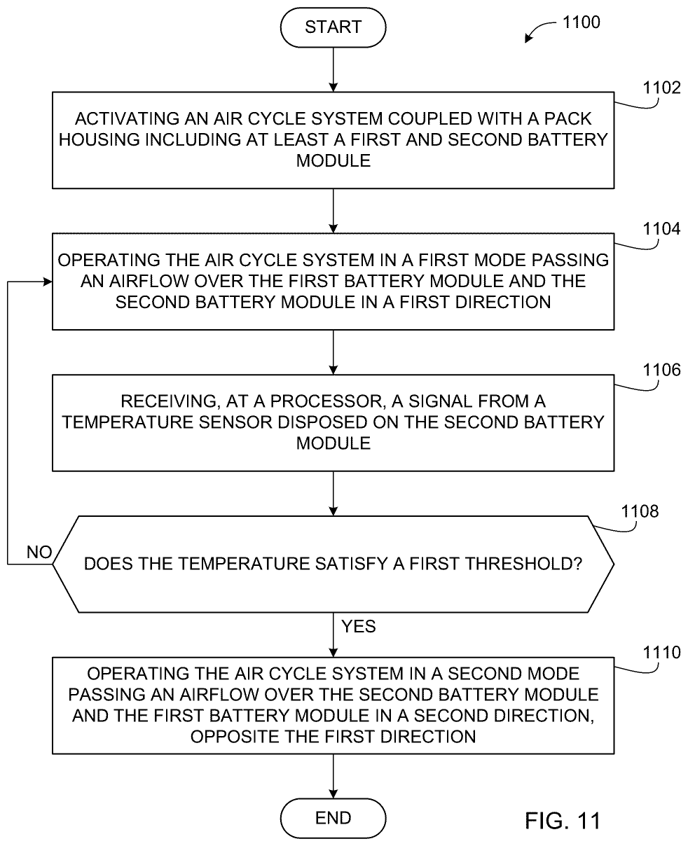

FIG. 11 illustrates a method 1100 of using a directed cooling system 1000 (or directed cooling systems 200, 400). At block 1102, the method 1100 includes activating an air cycle system coupled with a pack housing including at least a first battery module 1012a (in some examples, corresponding to the first battery module 212a of FIGS. 2-3 or the first battery module 412a of FIGS. 4-9) and second battery module 1012b (in some examples, corresponding to the second battery module 212b of FIGS. 2-3 or the fourth battery module 412d of FIGS. 4-9).

At block 1104, the method 1100 includes operating the air cycle system in a first mode, passing an airflow over the first battery module and the second battery module in a first direction. As shown in FIGS. 2 and 4-6, the first direction includes passing the airflow in a counterclockwise direction. But in various other examples, the first direction could be in any direction or along any flowpath.

At block 1106, the method 1100 includes receiving, at the processor 1032, a signal, conveying temperature data, from a temperature sensor 1046 disposed on the second battery module 1012b. In various other examples, the processor 1032 could receive the signal from a temperature sensor 1046 disposed on any battery module in the directed cooling system 1000.

At block 1108, the processor 1032 compares the temperature sensor data to a temperature threshold. If the temperature sensor data satisfies a temperature threshold, the method 1100 proceeds to block 1110. If the temperature sensor data does not satisfy a temperature threshold, the method 1100 returns to block 1104. At block 1110, the processor 1032 causes the air cycle machine to operate in a second mode, passing the airflow over the second battery module and over the first battery module in a second direction. As shown in FIGS. 3 and 7-9, the second direction includes passing the airflow in a clockwise direction. But in various other examples, the second direction could be generally opposite the first direction.

In the first mode the airflow first passes over the first battery 1012a but in the second mode the airflow first passes over the second battery 1012b. As a result, the airflow cools the first battery 1012a more than the second battery 1012b in the first mode and the airflow cools the second battery 1012b more than the first battery 1012a in the second mode.

In other examples, the directed cooling system 1000 may switch between the first mode and the second mode based on the operation of a timer or other control system.

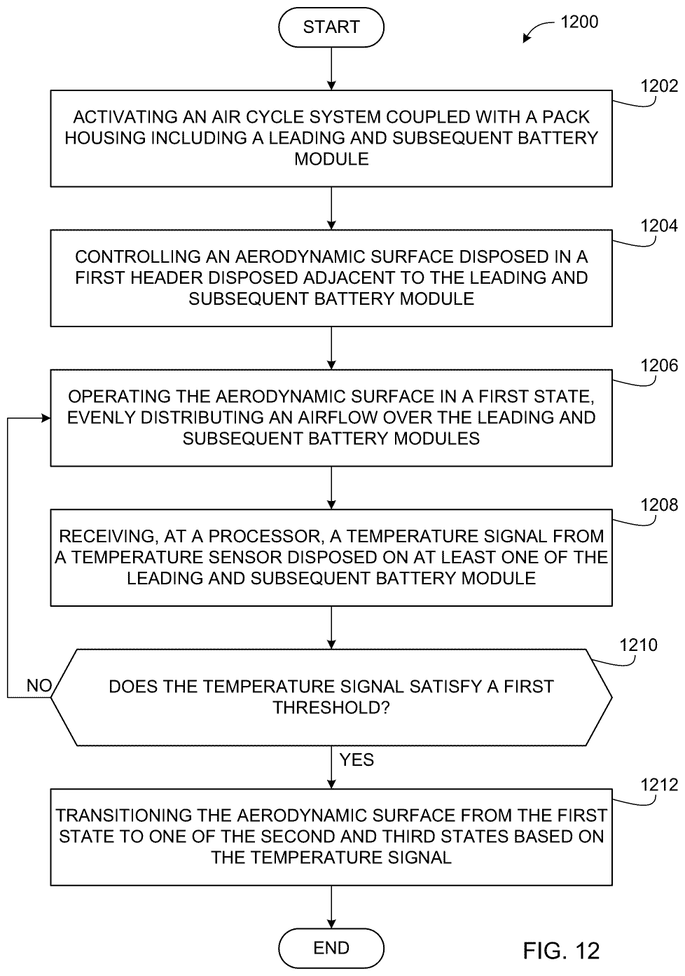

FIG. 12 illustrates another method 1200 of using a directed cooling system 1000 (or directed cooling systems 400). At block 1202, the method 1200 includes activating an air cycle system 1020 coupled with a pack housing (e.g., pack housing 202, 402) including a proximal battery module 1012a (corresponding, in some examples, to the first battery module 412a or the fourth battery module 412d) and distal battery module 1012b (corresponding, in some examples, to the second battery module 412b or the third battery module 412c).

At block 1204, the method 1200 includes controlling aerodynamic surfaces 1035 disposed in a first header 1034a (corresponding, in some examples, to one of the first header 434a or the second header 434b) disposed adjacent to the proximal and distal battery modules 1012a, 1012b. At block 1206, the method 1200 includes operating the aerodynamic surfaces 1035 in a first state, uniformly distributing an airflow over the proximal and distal battery modules 1012a, 1012b.

At block 1208, the method 1200 includes receiving, at a processor 1032, a signal from a temperature sensor 1046 disposed on at least one of the proximal and distal battery modules 1012a, 1012b. In various examples, every battery module in the pack housing include a temperature sensor. At block 1210, the processor 1032 determines whether the temperature satisfies a temperature threshold. In various examples, the temperature threshold may be a predetermined temperature threshold and may be set to prevent heat damage to the battery packs or may be set to prevent inefficient battery operation. If the temperature does not satisfy the temperature threshold, the method 1200 returns to block 1206. If the temperature does satisfy the temperature threshold, the method 1200 proceeds to block 1212.

At block 1212, the method includes transitioning the first header from a first state to one of a second state (as illustrated in FIGS. 5 and 8) or third state (as illustrated in FIGS. 6 and 9). For example, when the temperature sensor detects the distal battery module 1012b satisfies the temperature threshold, the aerodynamic surfaces could operate in the second state and pass an increased airflow over the distal battery module 1012b and cool it quicker. Alternatively, if the proximal battery module 1012a satisfies the temperature threshold, the first header be controlled to operate in the third state and pass an increased airflow over the proximal battery module 1012a. Further, if both the proximal and distal battery modules 1012a, 1012b satisfy the temperature threshold, the first header could be operated in the first state to pass the airflow evenly over the proximal and distal battery modules 1012a, 1012b.

Alternatively, the first header could be operated to pass an airflow based on a temperature gradient detected by the temperature sensors disposed on all of the battery modules. As a result, the first header could be controlled to pass a proportional portion of the airflow over the hottest battery modules. In one example, the first and second headers include actuatable structures to control the distribution of airflow. For example, the first and second headers could include orifices that can have changeable sizes. The size of the orifices would be controlled based on signals generated in the processor 1032 in response to temperature signals received in the temperature sensors 1046. As a result, the processor 1032 can control distribution of airflow throughout the pack housing.

In accordance with the present disclosure, the present directed cooling thermal management system provides many benefits over the known designs. First, the directed cooling capabilities will ensure the battery pack modules disposed within the pack housing are maintained at acceptable temperatures. This will increase the longevity of the battery pack modules disposed within the pack housing. Additionally, the directed cooling is a more efficient use of energy because the cooled airflow is applied where the temperature transfer will most efficiently and effectively cool the battery pack modules.

Those skilled in the art will recognize that a wide variety of modifications, alterations, and combinations can be made with respect to the above described examples without departing from the spirit and scope of the invention(s) disclosed herein, and that such modifications, alterations, and combinations are to be viewed as being within the ambit of the inventive concept(s).

What is claimed is:

1. A directed cooling system comprising:
a pack housing defining an enclosed volume;
a first battery module disposed within the enclosed volume;
a second battery module disposed within the enclosed volume adjacent the first battery module;
an air cycle system operating in a first mode and a second mode, wherein
in the first mode the air cycle system passes an airflow into the enclosed volume, over the first battery module in a first direction, over the second battery module in the first direction, and out of the enclosed volume; and
in the second mode the air cycle system passes the airflow into the enclosed volume, over the second battery module in a second direction, opposite the first direction, over the first battery module in the second direction, and out of the enclosed volume.

2. The directed cooling system of claim 1, wherein the second battery module is disposed adjacent to the first battery module in the first direction, the directed cooling system further comprising:
a third battery module disposed adjacent to the first battery module in a third direction;
a fourth battery module disposed adjacent to the third battery module in the first direction and adjacent to the second battery module in the third direction.

3. The directed cooling system of claim 2, wherein the air cycle system further comprises a first header and a second header:
in the first mode, the air cycle system passes the airflow in a third direction through the first header, over the first battery module and the third battery module in the first direction, over the second battery module and the fourth battery module in the first direction, and in a fourth direction, opposite the third direction, through the second header;
in the second mode, the air cycle system passes the airflow in a third direction through the second header, over the second battery module and the fourth battery module in the second direction, over the first battery module and the third battery module in the second direction, and in a fourth direction, through the first header.

4. The directed cooling system of claim 3, further comprising at least one first aerodynamic structure in the first header and at least one second aerodynamic structure in the second header configured to uniformly distribute the airflow in the first header and the second header, respectively.

5. The directed cooling system of claim 1, further comprising a heat pump disposed outside the pack housing and configured to absorb heat from the airflow before passing the airflow into the pack housing.

6. The directed cooling system of claim 1, further comprising a switch having a first state and a second state;
wherein the air cycle system operates in the first mode when the switch is in the first state and the air cycle system operates in the second mode when the switch is in the second state.

7. The directed cooling system of claim 6, wherein the switch comprises at least one temperature sensor actuatable between the first state and the second state when a temperature satisfies a threshold.

8. The directed cooling system of claim 7, wherein the temperature sensor is disposed on or in one of the first battery module and the second battery module.

9. The directed cooling system of claim 8, wherein the air cycle system further comprises a heat pump.

10. A directed cooling system, comprising:
a pack housing defining an enclosed volume having a first side and a second side disposed opposite the first side;
a proximal battery module disposed within the enclosed volume adjacent the first side;
a distal battery module disposed within the enclosed volume adjacent the proximal battery module;
a first header disposed on the first side of the enclosed volume and including a first aerodynamic structure;
a second header disposed on the second side of the enclosed volume and including a second aerodynamic structure;
a plurality of channels disposed between the first side and the second side, a first channel disposed adjacent the proximal battery module, a second channel disposed between the proximal and distal battery modules, and a third channel disposed adjacent the distal battery module; and
an air cycle system passing an airflow into the enclosed volume through the first header, through the first, second, and third channels and over the proximal and distal battery modules, and out of the enclosed volume through the second header.

11. The directed cooling system of claim 10, the air cycle system further comprising a first mode and a second mode, wherein
in the first mode the air cycle system passes an airflow into the enclosed volume through the first header in a third direction, through the first, second, and third channels and over the first and second battery modules in a first direction; and out of the enclosed volume through the second header; and
in the second mode the air cycle system passes the airflow into the enclosed volume through the second header in a third direction, through the first, second, and third channels and over the first and second battery modules in a second direction; and out of the enclosed volume through the second header.

12. The directed cooling system of claim 11, further comprising a switch having a first state and a second state;
wherein the air cycle system operates in the first mode when the switch is in the first state and the air cycle system operates in the second mode when the switch is in the second state.

13. The directed cooling system of claim 12, wherein the switch comprises at least one temperature sensor actuatable between the first state and the second state when the temperature satisfies a threshold.

14. The directed cooling system of claim 13, wherein the temperature sensor is disposed on or in at least one of the first battery module and the second battery module.

15. The directed cooling system of claim 14, further comprising a first temperature sensor disposed on the first battery module and a second temperature sensor disposed on the second battery module;
wherein the aerodynamic structure is actuatable between a first state when the first temperature sensor satisfies a first threshold, a second state when the second temperature sensor satisfies a second threshold, and a third state when the first and second temperatures either do not satisfy the first and second thresholds, respectively, or satisfy the first and second thresholds, respectively; and
in the first state, the aerodynamic structure passes more airflow over the first battery module and less airflow over the second battery module;
in the second state, the aerodynamic structure passes more airflow over the second battery module and less airflow over the first battery module; and
in the third state, the aerodynamic structure passes airflow uniformly over the first battery module and the second battery module.

16. The directed cooling system of claim 10, wherein the aerodynamic structure is configured to distribute the airflow between the plurality of channels.

17. The directed cooling system of claim 10, wherein the air cycle system further comprises a heat pump.

18. A method of operating a cooling system comprising at least two battery modules disposed adjacent one another in a first direction within a pack housing via an air cycle system, comprising:
providing a processor in communication with the air cycle system and at least one temperature sensor disposed on or in each of the at least two battery modules;
operating the air cycle system, via the processor, in a first mode including passing an airflow over a first battery module in the first direction and over a second battery module in the first direction;
receiving, at the processor, a signal from the at least one temperature sensor disposed on or in the second battery module, wherein the signal is in response to the at least one temperature sensor satisfying a temperature threshold,
operating the air cycle system, via the processor and in response to the signal from the at least one temperature sensor, in a second mode including passing the airflow over the second battery module in a second direction, opposite the first direction and over a first battery module in the second direction.

19. The method of claim 18, wherein the second battery module is disposed adjacent to the first battery module in the first direction, and further comprising a third battery module disposed adjacent to the first battery module in a third direction a fourth battery module disposed adjacent to the third battery module in the first direction and adjacent to the second battery module in the third direction;
the cooling system further comprising a first air header including a first actuatable aerodynamic surface disposed adjacent the first and third battery modules and a second air headers including a second actuatable aerodynamic structure disposed adjacent the second and fourth battery modules, the method further comprising;
controlling, via the processor, the first actuatable aerodynamic surface to distribute the airflow over the first and third battery modules in the first mode; and
controlling, via the processor, the second actuatable aerodynamic surface to distribute the airflow over the second and fourth battery modules in the second mode.

20. The method of claim 19, further comprising at least one second temperature sensor disposed on or in the third battery module or the fourth battery module;
wherein the first and second actuatable aerodynamic surfaces are actuatable between a first state when the at least one first temperature sensor satisfies a first threshold and a second state when the at least one second temperature sensors satisfies a second threshold; and
in the first state, the first actuatable aerodynamic surface passes more airflow over the first battery module and less airflow over the third battery module;
in the second state, the first actuatable aerodynamic surface passes more airflow over the second battery module and less airflow over the first battery module.
